(19) United States
(12) Patent Application Publication
(10) Pub. No.: US 2009/0044011 A1
(43) Pub. Date: Feb. 12, 2009

(54) Systems, Devices and Methods for Managing Cryptographic Authorizations

(75) Inventors: William C. Russell, Sterling, VA (US); Joseph M. Braceland, Annandale, VA (US); Joseph C. Lloyd, Mount Airy, MD (US); Hisham Abraham, Vienna, VA (US); Michael D. Cumberledge, Gainesville, VA (US)

Correspondence Address: CROWELL & MORING LLP;INTELLECTUAL PROPERTY GROUP, P.O. BOX 14300, WASHINGTON, DC, 20044-4300, US

(73) Assignee: Mount Airey Group, Inc., Annandale, VA (US)

(21) Appl. No.: 12/101,363

(22) Filed: Apr. 11, 2008

Related U.S. Application Data
(60) Provisional application No. 60/923,675, filed on Apr. 16, 2007.

(51) Int. Cl. H04L 9/06; G06F 21/00

(52) U.S. Cl. 713/168

(57) ABSTRACT

Certain exemplary embodiments can provide a method that includes a proof of authorization for any number of activities within an organization, where the proof of authorization associates a specific set of rights, privileges, permissions and/or powers with a collection of entities, each of which has a distinct digital identity. The proof of authorization allows any entity within the collection of entities to interface with or access one or more specific categories of information and/or one or more physical resources within an organization, according to the set of rights privileges, permissions and/or powers established by the authorization proof. The authorization proof may further include references to authorization proofs issued by other organizations in a federation of organizations.

### CROSS REFERENCES TO RELATED APPLICATIONS

This application claims priority to pending U.S. Provisional Patent Application Ser. No. 60/923,675, filed Apr. 16, 2007, the disclosure of which is incorporated herein by reference.

### TECHNICAL FIELD

The present invention relates generally to secure communications and more specifically to schemes for managing authorizations apart from authentications.

### BACKGROUND OF THE INVENTION

Public and private organizations have recently implemented Public Key Infrastructure (“PKI”) technologies in order to provide robust identity authentication for individuals as well as systems, devices and processes. Such PKI authentication techniques may use a Public Key Certificate (“PKC”), which is a digital document that binds an identity to a public key in a way that makes it computationally very difficult to forge. While various PKI authentication techniques provide a foundation for cryptographically verifiable authentication, a number of drawbacks become evident when such authentication technologies are applied within a coalition or federation of organizations. In a coalition or federation, member organizations may wish to operate their own security domains without any interaction from other organizations. But at the same time, the member organizations may also wish to use common or interchangeable cryptographic authentication technologies so that individuals, systems, devices and processes that are certified within one organization can be granted access to resources within another organization in the same federation.

Various attempts have been made to facilitate the transfer of authentication information to achieve authorization. In some prior art systems, an authorization to access a resource or to perform an act may be incorporated directly into the authentication mechanism itself. As an example, a driver's license may be created using PKC technology to provide authentication information about an individual while also implicitly authorizing that individual to drive an automobile. That same driver's license, however, would not normally authorize the individual to travel to another country or to access a given database. For those actions, a different authorization would be required, since a driver's license is usually fixed and cannot be extended or updated dynamically to include new authorizations.

Authorization information may be placed in an extended portion of a PKC. This is usually undesirable, however, for at least two reasons. First, authorization information does not usually have the same lifespan as the binding of an identity to a public key. For example, one's identity may persist for many years, but one's authorization to travel to another country, may be granted, suspended, revoked, and reinstated, from time to time, for any number of reasons. Thus, when authorization information is placed in a PKC extension, the usual result is a shortening of the PKC's useful lifetime. Second, the PKC issuer may not be the authoritative source for the extended authorization information. Thus, to issue a new authorization, the PKC issuer must take additional steps to obtain the necessary authorization information from a separate, trusted authoritative source and to incorporate that authorization information into the extended portion of the PKC. Alternatively, a separate trusted authoritative source must issue the new authorization. In either approach, the placement of additional authorization information in a PKC becomes a difficult problem to manage as the number of authorizations and issuing organizations increases. For these reasons, it is often better to separate authorization information from authentication information provided by the PKC. Yet, at the same time, authorization information also must be bound to a specific identity.

In the field of internetworking and computer network engineering, Request for Comment (“RFC”) documents are well-known memoranda encompassing new research, innovations, and methodologies applicable to networking technologies. One such RFC memorandum, RFC 3281, defines a protocol for the use of an Attribute Certificate (“AC”) that can be used to assign various authorizations to a holder of the certificate. An AC thus provides a mechanism to grant any number of authorizations for a single PKC holder. For example, an AC may contain attributes that specify group membership, access control, data origin authentication, role, security clearance, or other authorization information associated with the AC holder. An AC is a digitally signed document that is bound to a specific PKC. The syntax for the AC is defined by the X.509 standard.

A complication associated with the X.509 standard is its focus on the list of attributes or authorizations for a specific AC holder associated with a given PKC. To create or add a new authorization, an issuing organization must update an individual holder's AC. In concept, this is not complex. But when an organization is managing authorizations for thousands of individuals, systems, devices and processes, each of which requires a separate individual AC to be located, retrieved and updated, the overall system becomes overly difficult to manage, due to the number of separate data objects (i.e., the ACs) that must be tracked, retrieved, updated and disseminated. Thus, when multiple organizations endeavor to work together to share authorization and authentication information using ACs, the data management problem may be significantly magnified. Moreover, AC issuers lack an efficient mechanism of managing and transferring authorization information across organizations within a coalition or federation.

### SUMMARY OF THE INVENTION

Exemplary embodiments of the present invention provide systems, devices and methods for managing authorizations in a federated environment. A federated environment is an association of distinct organizations, each of which agree to honor an identification of an entity together with one or more authorizations dynamically associated with that identification. Embodiments of the present invention eliminate the difficulties of separately managing authorizations that are tightly coupled to individual identities. By collecting authorization information for multiple identifications within a single data object called an authorization proof, and by providing a mechanism by which authorization proofs may be shared across member organizations in a federation, exemplary embodiments of the present invention provide systems, devices and methods for managing cryptographic authorizations within organizations belonging to a coalition or federation. An authorization proof is a persistent and cryptographically strong digital credential, such as a digital file, object, record, message, and/or piece of data, that (1) is distinct from a digital identity of an entity; (2) specifies, via verifiable identifying information (such as a digitally-signed digest), an authorization of an entity to perform an action and/or receive and/or access one or more specific categories of information and/or one or more physical resources; and (3) is capable of being used by an organization of a federation to assign or determine an authorization associated with a digital identity of the entity, where an authorization is the assignment of a right, privilege, permission, and/or power.

Certain exemplary embodiments can provide a method that includes a proof of authorization for any number of activities, where the proof of authorization associates a specific set of rights, privileges, permissions and/or powers with a collection of entities, each of which has a distinct digital identity. The authorization proof allows any entity within the collection to interface with one or more specific categories of information and/or one or more physical resources, according to the set of rights privileges, permissions and/or powers established by the authorization proof.

In certain other exemplary embodiments, the present system, device and/or method can create and manage persistent authorizations, which can be verified after-the-fact to demonstrate that a given entity (including an individual and/or a device) was authorized to access information, perform certain duties, and/or operate in a specific manner based on a particular point in time and/or a given context. Digital signatures on electronic forms (“eForms”) are one example of the need for persistent authorization information. Signing an eForm can embed a digital certificate in an electronic form that can authenticate the fact that the signer is the real person signing the form. But the act of signing does not verify that the user who signed the document actually had the authorization to do so. Without persistent authorization—in addition to authentication—there might be no after-the-fact proof to show that a person who interfaced with one or more specific categories of information and/or one or more physical resources was actually allowed to do so. In the eForm example, when an eForm is saved, the authorization proof can be wrapped into the document and saved with the rest of the form. This can allow the authorization proof to remain with the document to verify that the authorization provided by the proof was valid when the document was signed. Systems and/or methods of exemplary embodiments can provide the ability to federate this authorization function while maintaining the same cryptographic rigor found in PKI for authentication.

Still other exemplary embodiments can provide a method of authorizing an entity to interface with one or more specific categories of information and/or one or more physical resources associated with an organization upon receiving a request from a client to verify the entity's authorization. Upon receiving the request for verification of an entity's authorization the method automatically obtains the entity's proof of identification, automatically validates the entity's proof of identification, automatically obtains an authorization proof associated with the organization; automatically verifies that the entity is specified in the authorization proof, and automatically provides to the client a verification of the authorization of the entity.

Additional exemplary embodiments can also provide a method of issuing a persistent, cryptographically strong, digital authorization proof that is distinct from a digital identity of an entity, where the authorization proof capable of specifying, via verifiable identifying information, an authorization of the entity to interface with one or more specific categories of information and/or one or more physical resources. The method may include the ability to reference other authorization proofs, and may also be utilized by a member of a federation to dynamically determine an authorization associated with the digital identity of the entity.

Further exemplary embodiments of the present invention can provide a method of automatically validating an authorization proof for one of a set of entities included in the authorization proof, where the authorization proof dynamically associates, for any member of a federation, an authorization of the entity with a distinct digital identity of the entity. If the validation is successful, the method may grant the entity permission to interface with one or more specific categories of information and/or one or more physical resources.

Unless specifically stated otherwise as apparent from the following discussions, it is understood that terms such as “processing” or “computing” or “calculating” or “determining” or “displaying” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission or display devices.

Other systems, methods, features and advantages of the invention will become apparent to one skilled in the art upon examination of the following figures and detailed description. It is intended that all such additional systems, methods, features and advantages included within this description are within the scope of the invention, and are protected by the accompanying claims.

### BRIEF DESCRIPTION OF THE DRAWINGS

FIG. 1 is a high-level block diagram of an exemplary system in accordance with the present invention;

FIG. 2 is a high-level block diagram of an exemplary embodiment of a system in accordance with the present invention;

FIG. 3 is a flowchart of an exemplary embodiment of a method in accordance with the present invention;

FIG. 4 is a block diagram of an exemplary embodiment of an information device in accordance with the present invention.

### DETAILED DESCRIPTION AND PREFERRED EMBODIMENTS

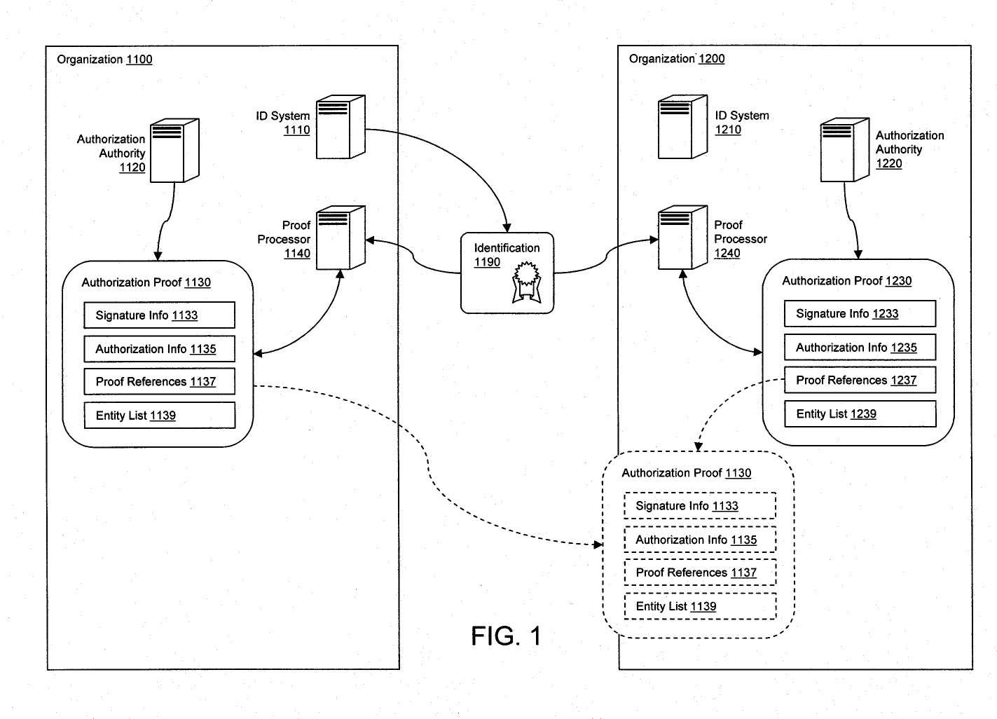

FIG. 1 is a high-level block diagram of an exemplary system in accordance with the present invention. The exemplary embodiments provide a system within which a federation, comprising at least organization 1100 and organization 1200, can manage and share persistent, cryptographically strong authorization proofs for entities whose identities have been authenticated by an organization in the federation. Organizations 1100 and 1200 may each correspond to a company, a government agency, or any other organization in a federation that is able to create and manage identities and proofs of authorization.

Within a federation, a member organization such as organization 1100 and organization 1200 may agree to honor an entity identification 1190 through the use of one or more persistent authorization proofs 1130 and/or 1230, which may be dynamically associated with identification 1190. For example, organization 1100 may create identification 1190 for an individual named Alice, using Identification System 1110. Similarly, organization 1200 may create identification 1190 using Identification System 1210. Identification 1190 may be created using any number of methods known in the art for creating cryptographically strong authentications of identity. Accordingly, identification 1190 may take the form of a PKC stored on a smart card or similar device. Other examples of suitable identification include articles that use a form of coded identification, such as credit cards, social security cards, passports, driver's licenses, Radio Frequency Identification (“RFID”) tags, tickets, and barcoded items.

Once identification 1190 has been created, it may be presented to any organization in the federation that maintains a proof processor such as proof processor 1140 or proof processor 1240. If proof processor 1140 or other equivalent security system in the federation, is able to authenticate the entity associated with identification 1190, (where the entity may correspond to an individual, system, device and/or process), the entity may be authorized to perform acts or be granted access to categories of information and/or resources within organization 1100, provided that information describing the entity associated with identification 1190 has been included within an authorization proof, such as authorization proof 1130.

To describe the contents of authorization proof 1130 and other data objects associated with exemplary embodiments of the invention, a data description language known as Abstract Syntax Notation One (“ASN.1”) may be used. As is known, ASN.1 is a formal notation used for describing data transmitted by telecommunications protocols, regardless of language implementation and physical representation of the data. ASN.1 abstractly describes messages to be exchanged among an extensive range of applications involving the Internet, intelligent network, cellular phones, ground-to-air communications, electronic commerce, secure electronic services, interactive television, intelligent transportation systems, Voice Over IP and others known to those skilled in the art. Due to its streamlined encoding rules, ASN.1 is also reliable and ideal for wireless broadband and other resource-constrained environments. Its extensibility facilitates communications between newer and older versions of applications. In addition to ASN.1, other data description languages, including Markup Languages known in the art, may be used to describe or implement certain exemplary embodiments of the present invention.

Data objects associated with exemplary embodiments of the present invention are representative and may be structured or organized in any number of different fashions known in the art of software engineering and computer science.

### Authorization Proof

To manage authorizations within a federation, Authorization Authority 1120 within organization 1100 may create and manage persistent authorization proof 1130 to establish authorizations for certain authenticated entities. For example, organization 1100 may utilize authorization proof 1130 to record information about certain entities that are authorized to access facilities classified as “SECRET.” Once authorization proof 1130 has been created, it may then be shared among cooperating organizations in a federation. Thus, still referring to FIG. 1, organization 1100 may send a copy of authorization proof 1130 to organization 1200, which may then use authorization proof 1130 to grant authorizations to the entity associated with identification 1190.

Authorization proof 1130 may be created using a secured application such as Authorization Authority 1120, and authorization proof 1130 may be used within any organization in a federation for purposes of authorizing entities to perform acts or be granted access to categories of information and/or resources within that same organization, or any another organization within a federation.

Authorization proof 1130 may comprise a persistent data object that is a collection of components that may include cryptographically strong signature information 1133, authorization information 1135, proof references 1137 and entity list 1139.

In exemplary embodiments, the components of authorization proof 1130 may be organized in a number of known fashions. As shown in FIG. 1, components of authorization proof 1130 may be identified and defined separately. In other exemplary embodiments, each element of a component of authorization proof 1130 may be defined alone, without regard to membership in a specific component. In still other exemplary embodiments, authorization proof 1130 may be implemented as an encapsulating data structure that includes nested data elements corresponding to the remaining components and/or elements of authorization proof 1130. Such nesting of components and/or data elements is not necessary, and other known methods of defining components and data elements may be used. Nevertheless, in certain exemplary embodiments, authorization proof 1130 may include the following components or data elements, which are described using ASN.1 syntax:

| AuthorizationProof ::= SEQUENCE { | |
|---|---|
| tbsAuthorizationProof | TBSAuthorizationProof, |
| signatureAlgorithm | AlgorithmIdentifier, |
| signatureValue | BIT STRING |
| } | |

### Signature Information

Referring to the above ASN.1 definition of authorization proof 1130, the elements signatureAlgorithm and signatureValue may together correspond to signature information 1133 as shown in FIG. 1. The element signatureAlgorithm may indicate a specific cryptographic algorithm that was used to create the element signatureValue. Other known methods of defining cryptographically strong signatures may also be used. A cryptographically strong signature may reduce or eliminate data tampering and thus enable the information held within the remainder of authorization proof 1130 to be trusted. The structure of signature information 1133 may follow the conventions of Public Key Infrastructure security objects or its equivalent, and may be embodied using digital signatures as defined in any of the following RFC standards: RFC 3279, RFC 4055, and/or RFC 4491, and/or related Errata.

### Authorization Information

Still referring to FIG. 1, authorization proof 1130 may include an authorization information 1135 component that defines metadata information about the authorization itself. As is known, elements of authorization information 1135 may be identified and defined separately or may be combined with elements of other components, using data nesting techniques or other techniques of data inclusion. Such nesting of components and/or data elements is not necessary, and other known methods of defining components and data elements may be used. In certain exemplary embodiments, authorization information 1135 may comprise the following structure of components or data elements, as described using ASN.1 syntax:

| TBSAuthorizationProof ::= SEQUENCE { | |
|---|---|
| version | INTEGER, |
| issuer | ProofReference, |
| subject | ProofReference, |
| validityPeriod | ValidityPeriod, |
| references | ReferenceMap, |
| entityDigestList [0] | DigestList OPTIONAL |
| extensions [1] | Extensions OPTIONAL |
| } | |

Within authorization information 1135, a version element may indicate a specific version or sequence number of authorization proof 1130 itself. The version element of authorization information 1135 may be a simple integer data type and may also be implemented using other known data types for describing versioning information.

The issuer element of authorization information 1135 may contain information describing an authorization authority, such as authorization authority 1120, which issues an authorization proof 1130 for an organization in the federation. The issuer element may be a compound data structure referred to herein as a ProofReference, which may include the following data elements, as described using ASN.1 syntax:

| ProofReference::= SEQUENCE { | |
|---|---|
| referenceDN | Name, |
| proofID | ProofIdentifier, |
| signedProofID | BIT STRING, |
| distributionPoint | ProofDistributionPoints, |
| certificate [0] | Certificate OPTIONAL |
| } | |

A ProofReference is a compound data structure that may include a reference name (“referenceDN”), a proof identifier (“proofID”), a signed proof identifier (“signedProofID”) a distribution point (“distributionPoint”) and a digital certificate (“certificate”). The referenceDN element may correspond to a Distinguished Name (“DN”), which is a known method of identifying a specific entry in a directory that may be implemented using a standard protocol such as the Lightweight Directory Access Protocol, or LDAP. As is known in the art, LDAP is an application protocol for querying and modifying directory services running over networks, such as TCP/IP. LDAP is described further in RFC 4510 and related documents.

The ProofReference compound data structure may include a proof ID element, which may correspond to an identifier representing the authorization proof 1130 itself. The proof ID element may be a compound data structure referred to herein as a ProofIdentifier, which may include the following data elements, as described using ASN.1 syntax:

| ProofIdentifier ::= SEQUENCE { | |
|---|---|
| authorityKeyIdentifier | KeyIdentifier, |
| issuerDN | Name, |
| serialNumber | INTEGER |
| } | |

The ProofReference compound data structure may also include a signedProofID element, corresponding to a signed proof identifier of an authorization security system (such as authorization authority 1120) for the organization that is the original authority that issued authorization proof 1130. The signedProofID may be created using a combination of the issuer's private key and the proof ID following RFC 3279, RFC 4055, and/or RFC 4491, and/or related Errata to create a digitally signed identifier. The resulting signedProofID can be referenced by any other organization or authority and may be verified using the public key of the issuing authority. The signedProofID element can enable persistent and/or federated authorizations between two or more authority organizations across various security domains. The signedProofID element may also demonstrate a relationship between existing branches of authority within one security domain.

The ProofReference compound data structure may additionally include a distributionPoint element. A distributionPoint is a network location where authorization proof 1130 was obtained and/or where an updated version may also be obtained. In certain exemplary embodiments, the distributionPoint element may correspond to a Universal Resource Locator (“URL”) or an LDAP entry.

Finally, the ProofReference compound data structure may include a certificate element. In a “root” authorization proof (i.e. an authorization proof that resides at the top of a hierarchy of authentication proofs), a certificate may correspond to a digital certificate of authorization system 1120. But in other proofs, a certificate may be used in other ways. For example a certificate may be used to enable a software application to validate an action taken in accordance with an authorization proof. For example, certain applications may require further cryptographic verification using digital certificates before an authorization may continue.

Returning to authorization information 1135, a subject element may contain information describing the subject of authorization proof 1130 corresponding to descriptive information associated with the authorization.

Authorization information 1135 may also contain a validityPeriod element that may define a precise period of time during which authorization proof 1130 may be considered valid.

| ValidityPeriod ::= SEQUENCE { | |
|---|---|
| notBefore | GeneralizedTime, |
| nextAvailable | GeneralizedTime, |
| notAfter | GeneralizedTime |
| } | |

### Proof References

An authorization proof may contain references to other authorization proofs. Using such a reference can allow an authorization proof to be used within multiple security domains. Organizations in a federation can trust the referenced authorization proof to authorize entities listed within it. For example, in FIG. 1, authorization authority 1120 of organization 1100 has created authorization proof 1130. Similarly, authorization authority 1220 of organization 1200 has created authorization proof 1230. Authorization proof 1230 may have the same component structure as authorization proof 1130. That is, authorization proof 1230 may comprise a persistent data object which is a collection of component information that may include cryptographically strong signature information 1233, authorization information 1235, proof references 1237 and entity list 1239. Authorization proof 1230 may refer to other authorizations provided within authorization proof 1130 through components supplied in proof references 1237.

In certain exemplary embodiments, a reference to other authorization proofs may be provided as a reference component that is included, for example, in authorization information 1135 or in authorization information 1235. A reference component may further define types of references, including, for example, references to a superior authorization proof, a number of peer authorization proofs, and/or a number of subordinate authorization proofs. Each reference can describe a relationship between the current authorization proof and other authorization proofs. The following are potential reference types, as defined using ASN.1 syntax:

ReferenceMap ::= SEQUENCE {

| | |
|---|---|
| superior | AuthorizationReference, |
| peer [0] | SET OF AuthorizationReference OPTIONAL, |
| subordinate [1] | SET OF AuthorizationReference OPTIONAL |
| } | |

AuthorizationReference ::= SEQUENCE {

| | |
|---|---|
| subject | ProofReference, |
| issuer | ProofReference |
| } | |

Referring to FIG. 1, authorization proof 1230 may reference authorization proof 1130 through proof references 1237. This reference by authorization proof 1230 to authorization proof 1130 may permit organization 1200 to use authorizations supplied by organization 1100 in addition to authorizations supplied within authorization proof 1230, which organization 1200 creates for itself. Using the earlier example of Alice, organization 1100 may create identification 1190 for Alice, using ID system 1110. Cryptographic information describing Alice's identification 1190 may then be added to authorization proof 1130 (by appending Alices' information to entity list 1139) to indicate that Alice is, for example, permitted to access information classified as “SECRET.” By agreement between organization 1100 and organization 1200, a copy of authorization proof 1130 can be exchanged through any number of mechanisms known in the art.

Once organization 1200 has obtained a copy of authorization proof 1130, authorization authority 1220 may then modify proof references 1237 within authorization proof 1230 to refer to the copy of authorization proof 1130. Then, for example, when Alice's credentials are presented to proof processor 1240 at organization 1200, proof processor 1240 will be able to access authorization proof 1230, traverse the list of proof references 1237, access the copy of authorization proof 1130, and determine that Alice is in fact authorized to access “SECRET” information.

### Entity Lists

Recall that an entity, within the context of exemplary embodiments of the present invention, may include individuals, systems, devices, processes, and the like. In certain exemplary embodiments, an authorization proof, such as authorization proof 1130 or 1230, may include a list of descriptions or digests of entities that are authorized to perform acts or be granted access to categories of information and/or resources, according to the information specified in authorization proof 1130 or 1230.

Referring again to FIG. 1, authorization proof 1130 may include an entity list 1139 describing the entities to which the authorizations specified in authorization information 1135 will be granted. Entity list 1139 may be implemented as a separate component of authorization proof 1130, as shown in FIG. 1, or entity list 1139 may be included as an element of another component within authorization proof 1130, for example. In certain exemplary embodiments, authorization information 1135 may include an entityDigestList element that defines the information required to specify the identification of entities to be authorized. As illustrated above with respect to the list of elements comprising authorization information 1135, entityDigestList may be a DigestList, as described by the following ASN.1 representation:

DigestList ::= SEQUENCE {

| | |
|---|---|
| digestAlgorithm | AlgorithmIdentifier, |
| digests | SET OF ObjectReference |
| } | |

ObjectReference ::= SEQUENCE {

| | |
|---|---|
| subjectKeyIdentifier [0] | SubjectKeyIdentifier OPTIONAL, |
| objectDigest | Digest |
| } | |

Each entityDigestList element may comprise a DigestList object that can store information for use in identifying entities. Entity identifying information may vary from application to application, and thus the corresponding data objects may also vary in their content and structure. In exemplary embodiments, entity identifying information may be supplied within an ObjectReference structure containing a subject key identifier and an object digest, as is known in the art. In other exemplary embodiments, identifying information may include hash values of security objects such as PKI certificates, or other coded identifiers useful for identifying an entity. An entityDigestList can be used to reference many different kinds of entity identities or authentication objects, including credit cards, smart cards, frequent buyer cards, or other identity objects that can be reduced to a digital representation.

### Extensions

The authorization proofs described herein are exemplary embodiments. Each of the components of authorization proofs may be extended using standard techniques known in the art. For example, authorization information 1035 includes an extensions element explicitly. Using such an extensions element, additional information may be added to an authorization proof without the need to change the structure and while maintaining consistency with previously provided authorization proofs.

Authorization proofs may be archived for later review and auditing. In such an audit, a given entity may be shown, for example, to have been authorized to access a given resource at a given time.

### System Architecture

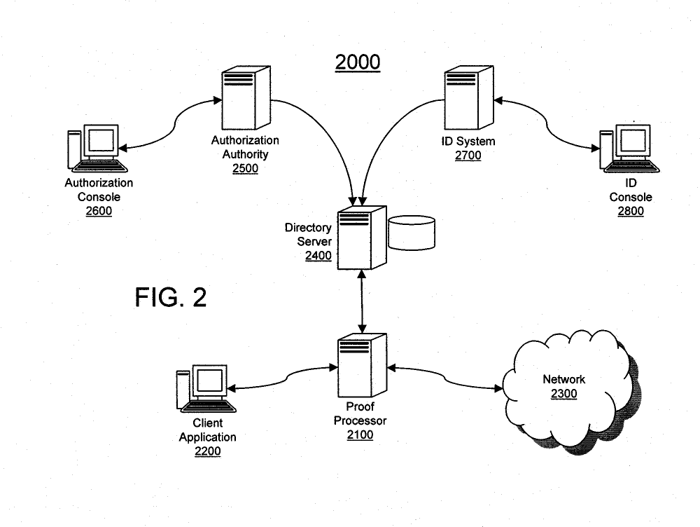

FIG. 2 is a high-level block diagram of an exemplary embodiment of a system 2000 in accordance with the present invention. System 2000 may comprise three (3) components that were previously described with referenced to FIG. 1: proof processor 2100, authorization authority 2500 and ID system 2700.

### ID System

ID system 2700 in FIG. 2 appears as ID system 1110 and ID system 1210 in FIG. 1. In certain exemplary embodiments, ID system 2700 can issue entity identifications, such as identification 1190 (see FIG. 1) according to any one of numerous methods known in the art. ID system 2700 may include its own user interface subsystem or may alternatively use a separate ID console 2800.

### Authorization Authority

Authorization authority 2500 in FIG. 2 appears as authorization authority 1120 and authorization authority 1220 in FIG. 1. In certain exemplary embodiments, authorization authority 2500 can manage creation and/or storage of authorization proof data.

Via certain exemplary embodiments, authorization proofs created by authorization authority 2500 can be encoded using Distinguished Encoding Rules (DER) as defined in section 8.7 of the X.509 standard.

Authorization proof data may be stored in a database, either locally or on directory server 2400. Schedules can be run from within authorization authority 2500 to generate and/or update authorization proofs and to publish authorization proofs to a directory server 2400.

Authorization authority 2500 can allow an entity to access a resource by adding the entity's authentication information to an authorization proof. The authentication information can be a hash from the entity's identification certificate (such as identification 1190 in FIG. 1) and/or any object that can be represented in digital form. Authorization authority 2500 administers the authorization proofs. Authorization authority 2500 may include its own user interface subsystem or may alternatively use a separate authorization console 2600.

### Proof Processor

In certain exemplary embodiments, proof processor 2100 can be used by client applications, such as client application 2200, to validate and/or determine user authorizations associated with their identification credentials (such as identification 1190 in FIG. 1). Proof processor 2100 in FIG. 2 appears as proof processor 1140 and proof processor 1240 in FIG. 1. Proof processor 2100 can be run as a web service. It can also be installed on an application server and/or can use API's for validating authorization requests. Proof processor 2100 can be used as a proxy for fetching external authorization proofs that are not in the security domain's infrastructure. Proof processor 2100 can use X.500 LDAP directories and/or other proof processors to retrieve authorization proofs. The authorization proofs can be stored and fetched from directory server 2400 and/or other locations accessible via network 2300.

In exemplary embodiments, proof processor 2100 can be a server to which client application 2200 will connect for the purpose of validating a user's authorizations. Proof processor 2100 can receive requested authorizations from client application 2200, or through network 2300. Proof processor 2100 may then connect to directory server 2400 to retrieve the desired authorization proof (such as authorization proof 1130 in FIG. 1). Proof processor 2100 can validate the proof, verify that the entity identification (such as identification 1190) is contained within the requested authorization proof, and/or return the result to client application 2200. Proof processor 2100 may also return the entire authorization proof object (denominated AuthorizationProof above) to client application 2200 so client application 2200 can cache the authorization proof locally. Communication with proof processor 2100 may be established via, for example, an Application Programming Interface (API) or as a web service through network 2300.

In other exemplary embodiments, particularly embodiments where the functionality of directory server 2400 is distributed across proof processor 2100, authorization authority 2500 and ID system 2700, proof processor 2100 can communicate directly with authorization authority 2500 and ID system 2700.

### Directory Server

Certain exemplary embodiments may include a directory server 2400 to handle the storage of each digital identification certificates (such as identification 1190) and/or the storage of authorization proofs (such as authorization proof 1130). Proof processor 2100 can write to directory server 2400 on a scheduled basis to publish and/or update authorization proofs. Each proof processor in other organizations within the federation can access directory servers associated with member organizations to retrieve authorization proofs on a scheduled and/or on-demand basis.

In certain exemplary embodiments, authorization authority 2500, ID system 2700 and/or proof processor 2100 can communicate with directory server 2400 using the X.500 LDAP and/or LDAPS standard protocols.

### Proof Administration and Validation

In certain exemplary embodiments, authorization proofs can be published to a directory server at scheduled intervals. Each authorization proof can be assigned to a schedule when it is created. Authorization authority 2500 can process each schedule, determine which authorization proofs are to be published according to that schedule, and/or publish them to directory server 2400.

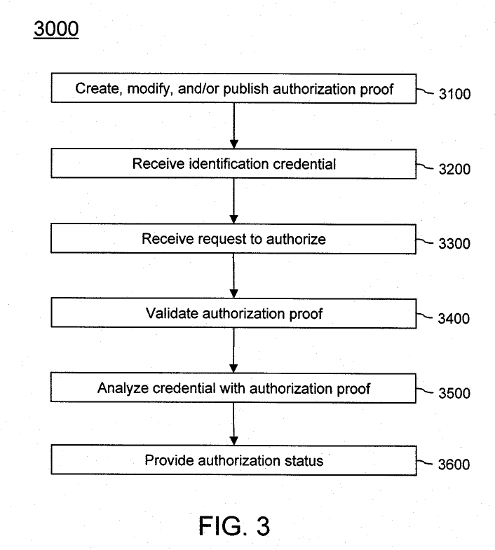

FIG. 3 is a flowchart of an exemplary embodiment of a method 3000. At activity 3100, a persistent, cryptographically strong, authorization proof can be created, reviewed, audited, modified, issued, published, and/or dynamically re-published. The authorization proof can be: included in an electronic document and/or form, described using an abstract syntax and/or notation, encoded using encoding rules, and/or related to a role for which an entity is authorized. The authorization proof can be capable of and/or adapted for operatively: specifying, via verifiable identifying information, an authorization of an entity to interface with one or more specific categories of information and/or one or more physical resources; referencing other authorization proofs; and being utilized by any member of a federation to dynamically assign or determine the authorization associated with a digital identity of an entity.

At activity 3200, an entity's identification credential can be automatically discovered, obtained, retrieved, and/or received. The identification credential can then be authenticated.

At activity 3300, a request to validate an authorization of an entity to interface with one or more specific categories of information and/or one or more physical resources can be received, such as from a client information device.

At activity 3400, the authorization proof may be independently validated.

At activity 3500, a digest of identifying information of the entity can be automatically analyzed against the digest contained within the authorization proof.

At activity 3600, a validation of the authorization of the entity can be automatically transmitted to, provided to, and/or received by the client and/or each member organization of a federation, potentially on a predefined schedule. Subsequently, based on an automatic authentication of the identification credential of an entity, the entity can be automatically allowed to interface with one or more specific categories of information and/or one or more physical resources.

### Information Device

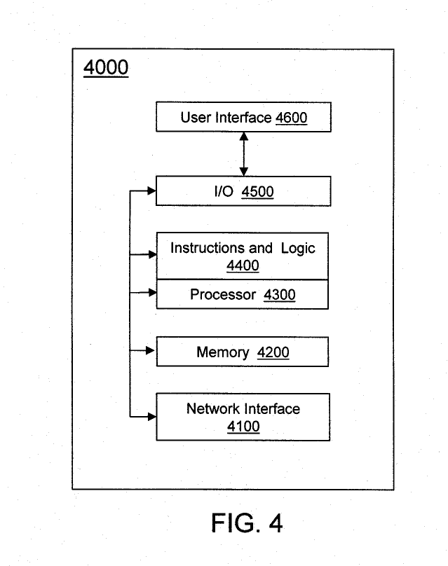

FIG. 4 is a block diagram of an exemplary embodiment of an information device 4000 in accordance with the present invention, which in certain operative embodiments can comprise, for example, the Authorization Console 2600, the Authorization Authority 2500, the ID Console 2800, the ID System 2700, the Client Application 2200, the Proof Processor 2100, and the Directory Server 2400 of FIG. 2. Information device 4000 can comprise any of numerous components, such as for example, one or more network interfaces 4100, one or more memories 4200, one or more processors 4300 including instructions and logic 4400, one or more input/output (I/O) devices 4500, and/or one or more user interfaces 4600 coupled to I/O device 4500, etc.

Information device 4000 may comprise any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.

Memory 4200 can be any type of apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.

Input/output (I/O) device 4500 may comprise any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

Instructions and logic 4400 may comprise directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.

Network interface 4100 may comprise any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.

Processor 4300 may comprise a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

User Interface 4600 may comprise any device and/or means for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

The foregoing disclosure has been set forth merely to illustrate the invention and is not intended to be limiting. It will be appreciated that modifications, variations and additional embodiments are covered by the above teachings and within the purview of the appended claims without departing from the spirit and intended scope of the invention. Other logic may also be provided as part of the exemplary embodiments but are left out here so as not to obfuscate the present invention. Since modifications of the disclosed embodiments incorporating the spirit and substance of the invention may occur to persons skilled in the art, the invention should be construed to include everything within the scope of the appended claims and equivalents thereof.

What is claimed is:

1. A method of automatically authorizing an entity to access a resource associated with at least a first organization in a federation, the method comprising the acts of:
receiving from a client at the first organization, a request to authorize the entity;
receiving a cryptographically signed proof of identification of the entity;
validating the proof of identification;
obtaining a cryptographically signed first authorization proof associated with the first organization, the first authorization proof distinct from the proof of identification, the first authorization proof including a reference to a distinct cryptographically signed second authorization proof associated with a second organization in the federation, the second authorization proof distinct from the proof of identification, the second authorization proof including a digital identity of at least one of a number of entities authorized to access the resource;
validating the first authorization proof;
validating the second authorization proof;
verifying that the entity is specified in the second authorization proof; and
providing to the client an authorization of the entity to access the resource.

2. The method of claim 1, wherein the resource comprises a category of information.

3. The method of claim 1, wherein the resource comprises a physical resource.

4. The method of claim 1, wherein the resource comprises an electronic resource.

5. The method of claim 1, wherein the verifying act comprises the act of:
confirming that the digital identity of the entity is specified in the second authorization proof.

6. The method of claim 1, further comprising:
receiving an update of the second authorization proof from the second organization.

7. The method of claim 1, wherein:
the first authorization proof is included within an electronic document.

8. A method of automatically authorizing an entity to access a resource associated with a first organization in a federation, the method comprising the acts of:
receiving from a client, a request to authorize the entity;
obtaining a first authorization proof associated with the first organization, the first authorization proof distinct from a proof of identification of the entity, the first authorization proof including a reference to a second authorization proof associated with a second organization in the federation, the second authorization proof specifying a digital identity of at least one of a number of entities authorized to access the resource; and
verifying that a digital identity of the entity is specified in the second authorization proof.

9. The method of claim 8, further comprising the acts of:
receiving from the client, the proof of identification of the entity; and
validating the proof of identification.

10. The method of claim 8, further comprising the acts of:
validating the first authorization proof; and
validating the second authorization proof.

11. The method of claim 8, further comprising the act of:
if the verification is successful, transmitting to the client an authorization of the entity to access the resource.

12. The method of claim 8, further comprising the act of:
auditing the second authorization proof.

13. The method of claim 8, wherein:
the first authorization proof is cryptographically signed.

14. The method of claim 8, wherein:
the proof of identification is cryptographically signed.

15. The method of claim 8, wherein:
the first authorization proof is described using a data description language.

16. The method of claim 15, wherein:
the first authorization proof is encoded using encoding rules associated with the data description language.

17. The method of claim 8, wherein:
the first authorization proof is implemented using a markup language.

18. A software product comprising a machine-readable medium having code sections that when executed:
receive from a client at a first organization in a federation, a request to authorize an entity to access a resource associated with at least the first organization;
receive from the client, a cryptographically signed proof of identification of the entity;
validate the proof of identification;
obtain a cryptographically signed first authorization proof associated with the first organization, the first authorization proof distinct from the proof of identification, the first authorization proof including a reference to a distinct cryptographically signed second authorization proof associated with a second organization in the federation, the second authorization proof distinct from the proof of identification, the second authorization proof including a digital identity of at least one of a number of entities authorized to access the resource;
validate the first authorization proof;
validate the second authorization proof;
verify that the entity is specified in the second authorization proof; and
provide to the client an authorization of the entity to access the resource.
